(19) United States
(12) Patent Application Publication
(10) Pub. No.: US 2022/0256848 A1
(43) Pub. Date: Aug. 18, 2022

(54) NEO-BAVAISOFLAVONE AND COMPOSITIONS THEREOF AND THEIR USE AS PESTICIDES

(71) Applicant: METABOLIC INSIGHTS LTD., Ness-Ziona (IL)

(72) Inventors: David PANIK, Rehovot (IL); Ido KORMAN, Sde Nitzan (IL)

(21) Appl. No.: 17/632,751

(22) PCT Filed: Aug. 6, 2020
(86) PCT No.: PCT/IL2020/050863

§ 371 Date: Feb. 3, 2022

(30) Foreign Application Priority Data
Aug. 6, 2019 (IT) 102019000014181

(51) Int. Cl. A01N 43/16; A01P 3/00; A01P 1/00

(52) U.S. Cl. CPC A01N 43/16; A01P 1/00; A01P 3/00

(57) ABSTRACT

A composition comprising neo-bavaisoflavone or an agriculturally acceptable salt thereof as an active pesticidal ingredient is provided. A method for controlling, preventing, reducing or eradicating the instances of plant-pathogen infestation on a plant, plant organ, plant part, or plant propagation material is further provided, the method comprising: applying to a plant, plant part, plant organ or plant propagation material, or to soil surrounding said plant, a pesticidal effective amount of an active agent comprising neo-bavaisoflavone or the pesticide formulation of claim 1, wherein said plant-pathogen is a member selected from: a class of Basidomycetes selected from Pucciniomycetes and Agaricomycetes; an oomycete of the family Pythiaceae; a bacterium of the order Pseudomonadales; and an Ascomycete of the family Sclerotiniaceae.

### FIELD OF THE INVENTION

The present invention relates in general to a plant secondary metabolite having fungicidal and bactericidal properties for agricultural uses.

### BACKGROUND OF THE INVENTION

Plant pests and diseases represent major challenges to productivity in modern agriculture. Rusts are a diverse group of plant pathogens with tens of genera and thousands of species. They have huge economic importance and may cause tens of percents loss in yield in cereals, maize and soybean (Gessese 2019; Groth et al., 1998; Hershman et al., 2011).

Puccinia spp. is an obligatory pathogenic fungus and a major genus in plant rusts belonging to phylogenetic lineage of Basidiomycetes. Puccinia spp. causes a wide range of commercially significant plant diseases in cereals (such as yellow rust in wheat) and maize (common rust)—(Gessese 2019; Groth et al., 1998).

Soil-borne plant pathogens cause crucial damage to agricultural crops. The phytopathogenic fungus Rhizoctonia spp. belongs to phylogenetic lineage of Basidiomycetes and causes a wide range of commercially significant plant diseases, such as brown patch, damping off in seedlings, root rot and belly rot. All Rhizoctonia diseases, and subsequent secondary infections, in plants are difficult to control (Erlacher et al., 2014). Adequate control of Rhizoctonia spp. is crucial for productivity of various agricultural crops such as rice and various vegetables.

Pythium spp. is phytopathogenic fungus-like organism which belongs to phylogenetic lineage of eukaryotic microorganisms called Oomycetes which causes the widespread “damping off” disease of various vegetables (Nzungize et al., 2012).

Phytophthora spp. is an obligatory plant fungal like pathogen which belongs to phylogenetic lineage of eukaryotic microorganisms called Oomycetes. Phytophthora infestans is a serious potato disease known as potato blight resulting in foliage blight and rot of tubers. The disease can cause complete loss of a potato harvest (Sedlakova et al., 2012). Phytophthora attacks the aerial parts of many plant species and it is the major cause of leaf blight, canker fruit rot diseases in tomato, pumpkins and other crops.

Sclerotinia spp. is a plant pathogenic fungus belonging to phylogenetic lineage of Ascomycetes. Sclerotinia spp. causes a disease called white mold in many plant hosts, most of them vegetables (Mizubuti, E. S. G 2019).

Pseudomonas spp. is a plant pathogenic bacterial genus which is virulent in the diverse arrays of crop plants and causes significant leaf and stem lesions. Pseudomonas spp. causes the following diseases in economically significant crops plants and orchards: pith necrosis in parsnip and tomato, brown blotch and leaf sheath brown rot in rice, bacterial canker in almonds and olive knot disease in olives (Moore L. W., 1988; Hofte M. and De Vos P., 2006). A variety of methods have been tested for the management of Pseudomonas spp. in crop plants. They include cultural management, host resistance, biological control with microbial antagonists, and chemical control. None of them gives full control.

The number of available active ingredients for crop protection purposes against these diseases is diminishing from year to year due to increasing pest resistance, erratic climatic conditions and mounting regulatory pressure. New active ingredients are urgently needed for development of novel environmentally sustainable crop protection solutions.

### SUMMARY OF INVENTION

In one aspect, the present invention is directed to a method for controlling, preventing, reducing or eradicating plant-pathogen infestation or instances thereof, on a plant, plant organ, plant part, or plant propagation material, the method comprising applying to a plant, plant organ or plant propagation material, or to the soil surrounding said plant, either a pesticidally effective amount of neo-bavaisoflavone or an agriculturally acceptable salt thereof or a pesticide composition comprising a pesticidally effective amount of neo-bavaisoflavone or an agriculturally acceptable salt thereof, wherein said plant-pathogen is a member selected from a class of Basidomycetes selected from Pucciniomycetes, and Agaricomycetes; an oomycete of the family Pythiaceae; a bacterium of the order Pseudomonadales; and an Ascomycete of the family Sclerotiniaceae.

In another aspect, the present invention provides a pesticide composition comprising neo-bavaisoflavone or an agriculturally acceptable salt thereof as an active pesticidal ingredient.

### BRIEF DESCRIPTION OF DRAWINGS

FIGS. 1-5 show effect of neo-bavaisoflavone (NBI) on corn leaf infection by Puccinia sorghi in five independent experiments, determined as leaf % covered by the fungus. *—p-value <0.05, **—p-value is <0.01, *** —p-value is <0.001. Signum—A reference fungicide containing 26.7% w/w boscalid and 6.7% w/w pyraclostrobin (BASF®). Fl, Formulation 1; F2, Formulation 2—see Example 5. ppm—parts per million.

FIG. 6 shows effect of neo-bavaisoflavone (NBI) on wheat leaf infection by Puccinia triticina in three independent experiments under greenhouse conditions, determined as leaf % covered by the fungus. Average of 3 independent experiments is presented. Formulation 1, see “Formulation preparation for in-planta validation” below.

FIG. 7 shows effect of neo-bavaisoflavone (NBI) on wheat leaf infection by Puccinia triticina in growth rooms under controlled temperature and light conditions, determined as leaf % covered by the fungus. Mean of 3 independent replicates is presented. ** means that p-value is <0.01. Formulation 1 see “Formulation preparation for in-planta validation” below.

FIGS. 8-9 show NBI effectiveness in preventing and controlling Puccinia stritiformis (yellow rust) in wheat plants from two different cultivars in curative approach (FIG. 8—Exp. 102; FIG. 9-Exp. 108). Formulation 3 and Formulation 4—see “Formulation preparation for in-planta validation” below.

### DETAILED DESCRIPTION OF THE INVENTION

The present invention is based on findings resulting from screening of libraries containing numerous plant secondary metabolites. It was found that neo-bavaisoflavone is a potent pesticide against several Basidomycetes fungi, oomycetes of the family Pythiaceae, bacteria of the order Pseudomonadales; and Ascomycetes of the family Sclerotiniaceae.

Neo-bavaisoflavone is a member of the class of 7-hydroxyisoflavones that is 7-hydroxyisoflavone with an additional hydroxy group at position 4′ and a prenyl group at position 3′. Neo-bavaisoflavone is found in plants which are mainly from the Fabaceae family (Bronikowska et al., 2010).

Thus, in one aspect, the present invention provides a method for controlling, preventing, reducing or eradicating plant-pathogen infestation or instances thereof, on a plant, plant organ, plant part, or plant propagation material, the method comprising: applying to a plant, plant organ or plant propagation material, or to soil surrounding said plant, a pesticidally effective amount of either neo-bavaisoflavone or a pesticide composition or formulation comprising neo-bavaisoflavone, wherein said plant-pathogen is a member selected from a class of Basidomycetes selected from Pucciniomycetes and Agaricomycetes; an oomycete of the family Pythiaceae; a bacterium of the order Pseudomonadales; and an Ascomycete of the family Sclerotiniaceae.

In certain embodiments, the plant-pathogen is a member of a class of Basidomycetes causing rust disease.

The method of treatment of the present invention is useful for example against the following common rust fungi in agriculture:
Cronartium ribicola (White pine blister rust); the primary host are currants, and white pines the secondary. Heterocyclic and macrocyclic.
Gymnosporangium juniperi-virginianae (Cedar-apple rust); Juniperus virginiana is the primary (telial) host and apple, pear or hawthorn is the secondary (aecial) host. Heteroecious and demicyclic.
Hemileia vastatrix (Coffee rust); Primary host is coffee plant; unknown alternate host. Heteroecious.
Phakopsora meibomiae and P. pachyrhizi (Soybean rust); Primary host is soybean and various legumes. Unknown alternate host. Heteroecious.
Puccinia coronata (Crown Rust of Oats and Ryegrass); Oats are the primary host; Rhamnus spp. (Buckthorn) is alternate host. Heteroecious and macrocyclic.

Puccinia graminis (Stem rust of wheat and Kentucky bluegrass, or black rust of cereals); Primary hosts include: Kentucky bluegrass, barley, and wheat; Common barberry is the palternate host. Heteroecious and macrocyclic.
Puccinia hemerocallidis (Daylily rust); Daylily is primary host; Patrina sp is alternate host.

Heteroecious and macrocyclic.
Puccinia persistens subsp. triticina causes wheat rust in grains. It is also known as ‘brown or red rust’.
Puccinia sorghi causes common rust in corn.
Puccinia striiformis causes ‘Yellow rust’ in cereals.
Puccinia melanocephala causes ‘Brown rust’ in sugarcane.
Puccinia kuehnii causes ‘Orange rust’ in sugarcane.
Uromyces appendiculatus causes Bean rust in common bean (Phaseolus vulgaris)
Uromyces phaseoli; Primary host: bean. Autoecious and macrocyclic.

In certain embodiments, the plant-pathogen is a member of the class Pucciniomycetes which contains 5 orders: Helicobasidiales, Pachnocybales, Platygloeales, Pucciniales, and Septobasidiales.

In certain embodiments, the Pucciniomycete plant-pathogen is a member of the order Pucciniales, which contains the following families: Chaconiaceae, Coleosporiaceae, Cronartiaceae, Melampsoraceae, Mikronegeriaceae, Phakopsoraceae, Phragmidiaceae, Pileolariaceae, Pucciniaceae, Pucciniosiraceae, Pucciniastraceae, Raveneliaceae, Sphaerophragmiaceae, Uncolaceae, Uropyxidaceae, mitosporic Pucciniales, and Pucciniales incertae sedis.

In certain embodiments, the Pucciniale plant-pathogen is a member of the family Pucciniaceae.

In certain embodiments, the Pucciniaceae plant-pathogen is a member of the genus Puccinia spp., for example Puccinia Sorghi, Puccinia triticina, Puccinia stritiformis (yellow rust), Puccinia coronate, Puccinia graminis, Puccinia hemerocallidis, Puccinia persistens subsp. Triticina, and Puccinia kuehnii.

In certain embodiments, the Pucciniale plant-pathogen is a member of the family Phakopsoraceae.

In certain embodiments, the Phakopsoraceae plant-pathogen is a member of the genus Phakopsora spp, for example Phakopsora pachyrhizi, Aeciure, Arthuria, Batistopsora, Bubakia, Catenulopsora, Cerotelium, Crossopsora, Dasturella, Kweilingia, Macabuna, Monosporidium, Newinia, Nothoravenelia, Phakopsora, Phragmidiella, Physopella, Pucciniostele, Scalarispora, Tunicopsora, Uredendo, Uredopeltis, and Uredostilbe,.

In certain embodiments, the Pucciniale plant-pathogen is a member of the family Pucciniale Incertae sedis.

In certain embodiments, the Pucciniale Incertae sedis plant-pathogen is a member of the genus Hemileia spp, for example Hemileia vastatrix.

In certain embodiments, the plant-pathogen is a member of the class Agaricomycetes, which contains several orders and subclasses: Agaricomycetidae, Agaricales, Amylocorticiales, Atheliales, Boletales, Jaapiales, Lepidostromatales, Phallomycetidae, Gomphales, Hysterangiales, Phallales, incertae sedis, Auriculariales, Cantharellales, Corticiales, Gloeophyllales, Hymenochaetales, Polyporales, Russulales, Sebacinales, Stereopsidales, Thelephorales, Trechisporales.

In certain embodiments, the plant-pathogen is a member of the order Cantharellales.

In certain embodiments, the Cantharellales plant-pathogen is a member of the family Ceratobasidiaceae, which includes the genera Ceratobasidium D.P. Rogers, Ceratorhiza R.T. Moore (anamorph), Rhizoctonia DC. (anamorph), Scotomyces Jülich, and Thanatephorus Donk.

In certain embodiments, the Ceratobasidiaceae plant-pathogen is a member of the genus Rhizoctonia spp, such as Rhizoctonia Solani.

In certain embodiments, the plant-pathogen is a member of the family Pythiaceae, which includes the genera Cystosiphon, Diasporangium, Globisporangium, Lagenidium, Myzocytium, Phytophthora, Pythium, and Trachysphaera.

In certain embodiments, the method of any one of the above embodiments is not effective against the genus Phytophthora, in particular against Phytophthora infestans.

In certain embodiments, the Pythiaceae plant-pathogen is a member of the genus Pythium spp., such as Pythium aphanidermatum.

In certain embodiments, the plant-pathogen is a member of the order Pseudomonadales, which includes several families: Moraxellaceae, Pseudomonadaceae, and Ventosimonadaceae.

In certain embodiments, the Pseudomonadales plant-pathogen is a member of the family Pseudomonadaceae, which includes the genera Azotobacter group, Azomonas, Azorhizophilus, Azotobacter, Mesophilobacter, Oblitimonas, Permianibacter, Pseudomonas, Rugamonas, and Thiopseudomonas.

In certain embodiments, the Pseudomonadaceae plant-pathogen is a member of the genus Pseudomonas spp, such as Pseudomonas syringae.

In certain embodiments, the plant-pathogen is a member of the family Sclerotiniaceae, which includes the genera: Asterocalyx, Botryotinia, Botrytis, Ciboria, Ciborinia, Coprotinia, Cudoniopsis, Dicephalospora, Dumontinia, Elliottinia, Encoelia, Grovesinia, Kohninia, Lambertellina, Martininia, Mitrula, Mitrulinia, Monilinia, Moserella (placement uncertain), Myriosclerotinia, Ovulinia, Phaeosclerotinia, Poculina, Pseudociboria, Pycnopeziza, Redheadia, Sclerocrana, Sclerotinia, Seaverinia, Septotinia, Streptotinia, Stromatinia, Torrendiella, Valdensinia, and Zoellneria.

In certain embodiments, the Sclerotiniaceae plant-pathogen is a member of the genus Sclerotinia spp, such as Sclerotinia sclerotiorum.

In certain embodiments, the method of any one of the above embodiments is not effective against the genus Botrytis, in particular against Botrytis cinerea.

The pesticide composition used in any one of the embodiments of the method of the present invention may be formulated into a formulation to facilitate application of the active pesticidal ingredient.

Thus, in an additional aspect, the present invention is directed to a pesticide composition or formulation comprising neo-bavaisoflavone or an agriculturally acceptable salt thereof as an active pesticidal ingredient.

In certain embodiment, the composition or formulation comprises a pesticidally effective amount of neo-bavaisoflavone.

In certain embodiments, the pesticide composition or formulation of any one of the above embodiments further comprises an agriculturally suitable or acceptable solvent or solubilizing agent.

In certain embodiments, the agriculturally acceptable solvent or solubilizing agent is a water-miscible solvent capable of dissolving or solubilizing neo-bavaisoflavone.

In certain embodiments, the water-miscible solvent capable of dissolving or solubilising neobavaisoflavone is a polar solvent, such as an alcohol, a ketone, a lactone, a keto-alcohol, a glycol, a glycoether, an amide, an alkanolamine, a sulfoxide and a pyrolidone.

In particular embodiments, the composition of any one of the above embodiments comprises a solvent selected from dimethyl-sulfoxide or ethanol.

The composition of the present invention may be a water-miscible formulation, such as a suspension concentrate (SC), a capsule suspension (CS), water-dispersable granules (WG), an emulsifiable concentrate (EC), a wettable powder (WP), a soluble (liquid) concentrate (SL), and a soluble powder (SP).

This composition may further comprise at least one solvent or solubilizing agent, thixotropic agent, adjuvant, carrier, diluent, and/or surfactant.

Non-limiting examples of adjuvants are activator adjuvants, such as polysaccharides; cationic, anionic or non-ionic surfactants; oils and nitrogen-based fertilizers capable of improving activity of the pesticide product.

A non-limiting example of a polysaccharide adjuvant, used also as a thixotropic agent in the compositions of the present embodiments, is Xanthan gum (commercially available under trademark KELZAN® by CP Kelco), which is produced from simple sugars using a fermentation process, and derives its name from the species of bacteria used, Xanthomonas campestris. Oils used as adjuvants may be crop oils, such as paraffin or naptha-based petroleum oil, crop oil concentrates based on emulsifiable petroleum-based oil, and vegetable oil concentrates derived from seed oil, usually cotton, linseed, soybean, or sunflower oil, used to control grassy weeds. Nitrogen-based fertilisers may be ammonium sulfate or urea-ammonium nitrate.

Non-limiting examples of solubilising agents or solvents are petroleum-based solvents, the aforementioned oils, liquid mixtures of fatty acids, ethanol, glycerol and dimethyl sulfoxide. The agriculturally acceptable solvent or solubilizing agent may be a water-miscible solvent capable of dissolving or solubilizing neo-bavaisoflavone, such as a polar solvent, e.g. an alcohol, a ketone, a lactone, a keto-alcohol, a glycol, a glycoether, an amide, an alkanolamine, a sulfoxide and a pyrolidone.

Non-limiting examples of carriers are precipitated silica, colloidal silica, attapulgite, china clay, talc, kaolin and combinations thereof.

The pesticide formulation of any one of the above embodiments may further comprise a diluent, such as lactose, starch, urea, water soluble inorganic salts and combination thereof.

The pesticide composition of any one of the above embodiments may further comprise one or more surfactants, for example, polysorbate-type nonionic surfactant, such as Polysorbate 20 (commercially available under trademark TWEEN-20® by Sigma), trisiloxane non-ionic surfactants, styrene acrylic dispersant polymers, acid resin copolymer based dispersing agents, potassium polycarboxylate, sodium alkyl naphthalene sulfonate blend, sodium diisopropylnaphthalenesulfonate, sodium salt of naphthalene sulfonate condensate, lignin sulfonate salts and combinations thereof. Trisiloxane non-ionic surfactants or polyetherdimethylsiloxanes (PEMS), often referred to as superspreaders or superwetters, are added to pesticides to enhance the activity and the rainfastness of the active substance by promoting rapid spreading over the hydrophobic surfaces of leaves. Silwet® L-77 spreader is a modified trisiloxane that combines a very low molecular weight trisiloxane with a polyether group and capable of reducing surface tension and rapidly spreading on difficult to wet surfaces.

The active agent, composition, or formulation comprising it, is applied in the method of any one of the above embodiments to the plant or part, organ or plant propagation material thereof by spraying, immersing, dressing, coating, pelleting or soaking.

### Definitions

The term “plant organ” as used herein refers to the leaf, stem, root, and reproductive structures.

The term “plant part” as used herein refers to a vegetative plant material such as a cutting or a tuber; a leaf, flower, blossom, inflorescence, bark or a stem.

The term “plant propagation material” as used herein refers to a seed, root, fruit, tuber, bulb, rhizome, or part of a plant.

The term “pesticidally effective amount” as used herein refers to an amount of the pesticide that is able to bring about death to at least one pest, or to noticeably reduce pest growth, feeding, or normal physiological development.

In certain embodiments, the pesticidal effective amount of neo-bavaisoflavone in any one of the above embodiments is up to about 2000 ppm or between 50-2000, 100-2000, 150-2000, 200-2000, 250-2000, 300-2000, 350-2000, 400-2000, 450-2000, 500-2000, 550-2000, 600-2000, 650-2000, 700-2000, 750-2000, 800-2000, 850-2000, 900-2000, 950-2000, 1000-2000, 1500-2000, 50-1500, 100-1500, 150-1500, 200-1500, 250-1500, 300-1500, 350-1500, 400-1500, 450-1500, 500-1500, 550-1500, 600-1500, 650-1500, 700-1500, 750-1500, 800-1500, 850-1500, 900-1500, 950-1500, 1000-1500, 50-1000, 100-1000, 150-1000, 200-1000, 250-1000, 300-1000, 350-1000, 400-1000, 450-1000, 500-1000, 550-1000, 600-1000, 650-1000, 700-1000, 750-1000, 800-1000, 850-1000, 900-1000, 950-1000, 50-950, 100-950, 150-950, 200-950, 250-950, 300-950, 350-950, 400-950, 450-950, 500-950, 550-950, 600-950, 650-950, 700-950, 750-950, 800-950, 850-950, 900-950, 50-900, 100-900, 150-900, 200-900, 250-900, 300-900, 350-900, 400-900, 450-900, 500-900, 550-900, 600-900, 650-900, 700-900, 750-900, 800-900, 850-900, 50-850, 100-850, 150-850, 200-850, 250-850, 300-850, 350-850, 400-850, 450-850, 500-850, 550-850, 600-850, 650-850, 700-850, 750-850, 800-850, 50-800, 100-800, 150-800, 200-800, 250-800, 300-800, 350-800, 400-800, 450-800, 500-800, 550-800, 600-800, 650-800, 700-800, 750-800, 50-750, 100-750, 150-750, 200-750, 250-750, 300-750, 350-750, 400-750, 450-750, 500-750, 550-750, 600-750, 650-750, 700-750, 50-700, 100-700, 150-700, 200-700, 250-700, 300-700, 350-700, 400-700, 450-700, 500-700, 550-700, 600-700, 650-700, 50-650, 100-650, 150-650, 200-650, 250-650, 300-650, 350-650, 400-650, 450-650, 500-650, 550-650, 600-650, 50-600, 100-600, 150-600, 200-600, 250-600, 300-600, 350-600, 400-600, 450-600, 500-600, 50-550, 100-550, 150-550, 200-550, 250-550, 300-550, 350-550, 400-550, 450-550, 500-550, 50-500, 100-500, 150-500, 200-500, 250-500, 300-500, 350-500, 400-500, 450-500, 50-450, 100-450, 150-450, 200-450, 250-450, 300-450, 350-450, 400-450, 50-400, 100-400, 150-400, 200-400, 250-400, 300-400, 350-400, 50-350, 100-350, 150-350, 200-350, 250-350, 300-350, 50-300, 100-300, 150-300, 200-300, 250-300, 50-250, 100-250, 150-250, 200-250, 50-200, 100-200, 150-200, 50-150, or 100-150 ppm. Similarly, the pesticidal effective amount of neo-bavaisoflavone in any one of the above embodiments is about 10, 20, 30, 40, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or 2000 ppm.

The term “agriculturally acceptable salt” as used herein refers, but is not limited to, alkali metal salts such as sodium and potassium salts; alkaline earth metal salts such as calcium and magnesium salts; ammonium salts such as unsubstituted ammonium salts and mono- or polysubstituted ammonium salts, as well as salts with other organic nitrogen bases. Typically, when present as a salt, neo-bavaisoflavone comprises a sodium salt of neo-bavaisoflavone.

The terms “class”, “order”, “family”, “genus”, and “species” are used herein according to Art 3.1 of the International Code of Nomenclature for algae, fungi, and plants.

Unless otherwise indicated, all numbers used in this specification are to be understood as being modified in all instances by the term “about”. Accordingly, unless indicated to the contrary, the numerical parameters set forth in this specification are approximations that may vary by up to plus or minus 10% depending upon the desired properties to be obtained by the present invention.

The invention will now be illustrated by the following non-limiting Examples.

### EXAMPLES

### List of Abbreviations:

2:PDBC—PDBC diluted 2 fold by sterile distilled water

CFU—Colony forming unit

DMSO—Dimethyl sulfoxide

LB—LB broth

LBA—LB agar

PDA—Potato dextrose agar

PDAC—Potato dextrose agar with 20 ug/ml chloramphenicol

PDBT—Potato dextrose broth with 12 ug/ml tetracycline

RCF—Relative centrifugal force

RPM—Revolutions per minute

SCH—Schmittner medium

### Example 1

### Microplate Based Assay of Neo-Bavaisoflavone Bioactivity against Puccinia sorghi

Background: Puccinia is a fungus of belonging to the Basidiomycetes, and it is an air borne pathogen. Puccinia spores were grown on corn plants, in a growth room, and fresh spore suspension was prepared from the infected corn leaves for each experiment. Since Puccinia is an obligatory pathogen and does not grow on synthetic medium, only the germination of the spores was monitored as indication for compounds bioactivity.

Summary: Diluted purified neo-bavaisoflavone was added to microplate wells and mixed with freshly prepared spore suspension and germination of the spores was monitored by visual inspection under the microscope.

Materials: Tween20 (Tidea Company INC) non-ionic detergent, DMSO—dimethyl-sulfoxide (J.T. Baker—Poland) solvent

Equipment: Centrifuge, Shaker, Incubator, Microscope

### Method

Puccinia spores Preparation

### Preparation of Corn Seedling for Inoculation:

1) Use 120×80×80 mm pots

2) Use standard garden soil with fertilizer

3) Use corn seeds of a sensitive variety

4) Put the pots in a small tray

5) Fill the pots with the soil to the top

6) Make a small round grove for the seeds

7) Plant about 10 seeds of corn in each pot

8) Cover the seeds with additional soil

9) Add water into the tray—about 100 ml for each pot. Soil should be wet, and no water should be left in the tray after 24 h

10) Grow the corn for 7 days, in growth room at 22° C. (until the second leaf is emerged)

Preparation of Spore Suspension [from Corn Leaves] for Inoculation and for Germination Study:

1) Insert 20 corn leaves with spores, into a sterile 50 ml tube

2) Add 50 ml of fridge cold 0.05% Tween 20 solution

3) Insert the tube into a sealed, ice cooled, plastic box

4) Shake the box using a shaker at 300 RPM for 15 min

5) Transfer the suspension (without the leaves) into a clean sterile 50 ml tube

6) Keep the tube with the spore suspension on ice

### Inoculation Preparation:

1) Dilute the spore suspension to get 300 ml using cold 0.05% Tween 20 solution

2) Check the spore concentration in the suspension—the concentration should be about 600 spores/ml and the suspension should have a light brown color

3) Keep the spore suspension on ice

### Germination Assessment:

1) Prepare filtration system with 5 micron membrane, and wash the membrane with the sterile cold water

2) Suspend and decant the spore suspension from the 50 ml tube slowly into the filtration system to the center of the membrane—spores should accumulate on the membrane

3) Wash the spores to discard bacteria and other fungi spores—stop the vacuum and spray cold sterile water to suspend and wash the spores, resume the vacuum

4) Repeat spore wash 2 more times

5) Insert the membrane with the spores into the tube with 30 ml sterile cold 0.05% Tween 20 and shake the tube by hand

6) Remove the membrane and discard it

7) Decant filtered liquid to the sink and wash the filtration system with tap water and dry it

8) Add 30 ul Chloramphenicol stock solution (20 mg/ml) up to final concentration of 20 ug/ml

9) Filter the spore suspension through 8 layers of gauze into a 50 ml tube.

10) Check the spore concentration in the suspension—the concentration should be about 7.5×10³ spores/ml and should have a brown color. Thirty ml of spore suspension should be enough for the screening of 20 microplates

11) Keep the spore suspension on ice

### Seedlings Infection:

1) Transfer the spore suspension into 250 ml beaker

2) Spin a 20 mm stirrer slowly (500 RPM) to keep spores in suspension and add ice around the beaker

3) Deep the leaves of all the seedlings in the pot into the spore suspension for 10 min

4) Put the pots with the inoculated seedlings in a moist chamber with heated water at 22° C. and 99% humidity for 24 h (heat the water to 32° C.)

5) After 24 h, transfer the pots to the growth room and cover the seedlings with the plastic bags

6) Grow the corn in growth room at 22° C.

7) After 7 days from inoculation, brown spots should be seen on the leaves

8) After 11 days from inoculation remove the plastic bags to prevent fungal contamination and use a rubber band to hold the seedlings together

9) After 12 days from inoculation leaves with spores may be collected for spore suspension preparation

### Microplate Preparation for Screening of Germinated Puccinia Spores:

1) Take a plate with Neo-bavaisoflavone from the −20° C. freezer and thaw it on the bench for at least 20 min

2) Take also a control plate with materials from the −20° C. freezer and thaw it on the bench for at least 20 min

3) All microplates should contain 10 ul of Neo-bavaisoflavone solution

4) Add 15 ul of Puccinia spore suspension to all wells of the all microplates. Suspend the spores by the pipette (up and down) before transferring the spore suspension into the wells

5) Seal all plates with transparent sealer

6) Centrifugate all test plate at 1000 RCF for 1s and stop to collect the liquid at the bottom of the plate

7) Shake all plates at 1000 RPM for 10s and check for spore dispersion in the well

8) Insert all plates to a plastic box and put the box in the incubator at 25° C. over night

### Screening of Plates:

1) Screen plate 12-24 h after suspension preparation using the microscope at 10×10 magnification

2) Compare spore germination of each well to spore germination of the control plate wells (wells containing active fungicides or 0.5% DMSO solution)

3) Report spore germination in Excel sheet:
type—1 if spores have germinated properly (normal tube elongation)
type—2 if spores have germinated poorly or not normal in any way (very short germination tubes, low frequency of germinating spores, damaged tubes)
type—3 if spores have not germinated at all (sound spores, no tubes)

4) Calculate the number of repeats of scores 2 or 3 for each material

5) Calculate the sum of scores of 2 and 3 for each material

6) Best score: number of repeats=4, sum of scores=12

### Results: Please see Example 6.

### Example 2

### Microplate Based Assay of Neo-Bavaisoflavone Bioactivity against Rhizoctonia Solani

Summary: Diluted purified neo-bavaisoflavone was added to microplate wells and mixed with 50 ul of hyphae suspension and growth of the fungus, starting from blended hyphae, was monitored by plate reader and visual inspection.

Materials: PDAC, PDBC, DMSO

Equipment: Plate reader, Centrifuge, Shaker, Incubator

### Methods:

Inoculum Preparation of Rhizoctonia solani Hyphae:

Grow Rhizoctonia on PDAC in 90 mm petri plates to get growing hyphae within 1-4 days.

Add 50 ml of PDBC medium into a sterile 250 ml Erlenmeyer flask.

Cut the solid medium by scalpel to several small pieces and insert them into the Erlenmeyer flask.

Grow the culture for 2-4 days using shaker at 27° C. and 150 RPM.

Discard the liquid and pour the hyphae on an empty Petri dish.

Cut many small pieces from the hyphae using a scalpel and insert them into a sterile 250 ml

Erlenmeyer flask with 50 ml of PDBC medium.

Prepare 4 bottles with culture and grow for 3 days at 27° C. shaking at 150 RPM.

Chill the culture in the fridge for 1 h.

Pour the cold culture into a 250 ml beaker.

Add 20 ml of cold PDBC, so that the mixture will cover the blender knife.

Blend the culture with a blender for 2 min on ice at maximum speed, move the blender up and down several times.

Keep the mixture on ice.

Transfer about 5 ml of the blended mixture into a 15 ml tube on ice.

Homogenize the culture in the 15 ml tube for 2 min on ice, move the tube up and down as needed.

Homogenize several batches of 5 ml as above to prepare the amount that is needed (5 ml of homogenized culture would make about 100 ml of inoculum).

Dilute a portion of the homogenate 10-fold to check the concentration of the homogenate. The concentration of the suspension should be 4×10⁴ CFU/ml (diluted 10-fold concentration should be 4000 CFU/ml).

Dilute the inoculum stock 1:20 in PDBC—1 ml in 20 ml, or calculate the dilution needed, to prepare final concentration of 2000 CFU/ml. The amount in each well should be 100 CFU.

### Microplate Preparation for Activity Experiment:

1) Take a plate, with materials from the −20° C. freezer and thaw it on the bench for at least 20 min

2) Add 50 ul of hyphae suspension to the wells of the microplate using a multi-pipette, mix the spore suspension vigorously by hand and decant amount needed for one plate (5 ml) to keep the hyphae well suspended

3) Seal the plate with transparent sealer

4) Shake the plate for 10 min at 2000 RPM to mix the neo-bavaisoflavone with the hyphae suspension

5) Centrifugate the plate at 1000 RCF for ls and stop to collect the liquid at the bottom of the plate

6) Keep the microplate on the bench until it is read by the plate reader

7) Read the plate using the plate reader

8) Collect the plates on the bench

9) Insert collected plates to a plastic box with cloth cover and put the box in the incubator at 27° C.

### Screening of Plates:

1) Screen plate at 3 more dates: 3d, 7d, 14d and 21d following the assay start

2) Calculate the difference of absorbance between each screen and the read at zero time

3) Calculate the percentage of growth inhibition of each well at each time point. Use the results of the DMSO treatment of the control plate as 100% growth

### Results: Please see Example 6.

### Example 3

### Microplate Based Screening of Compounds Purified from Plants with Potential Bioactivity against Pythium Aphanidermatum

Summary: Diluted purified neo-bavaisoflavone was added to microplate wells and mixed with 50 ul of zoospores in PDBC suspension and the growth of the fungus, starting from zoospores, was monitored by plate reader and visual inspection

Materials: SCH, PDBC, DMSO

Equipment: Plate reader, Centrifuge, Shaker, Incubator

### Methods:

Inoculum Preparation of Pythium hyphae:

Grow Pythium aphanidermatum on SCH in 90 mm petri plates to get sporulating hyphae.

Each plate will produce 50 ml of zoospores suspension which will yield ten 96-well plates.

Add 60 ml of sterile H₂O into a sterile 250 ml Erlenmeyer flask.

Cut the solid medium of 2 plates by scalpel to 12 pieces (each plate) and insert them into the

Erlenmeyer flask (the solid pieces should be covered by the water).

Let the hyphae sporulate overnight at 17° C.

Shake the Erlenmeyer flask by hand to suspend the zoospores.

Filter the suspension into 50 ml tube through 16-layer gauze.

Transfer the suspension into a sterile 500 ml bottle.

Discard the solids and disinfect the Erlenmeyer flask with hypochlorite.

Chill the zoospore suspension on ice.

Evaluate the zoospores concentration in the suspension (the concentration should be 1000-4000 spores/ml).

Dilute the suspension by sterile fridge cold distilled H₂O in a sterile 500 ml bottle if needed. Add the same volume (as the suspension) sterile fridge cold 2:PDBC to get 500-2000 spores/ml inoculum. This dilution will result in the amount of 25-100 zoospores in each well.

Keep the zoospore suspension inoculum on ice.

### Microplate Preparation for Activity Experiment:

1) Take a plate, with neo-bavaisoflavone from the −20° C. freezer and thaw it on the bench for at least 20 min

2) Add 50 ul of zoospore suspension inoculum to the wells of the microplate using a multi-pipette. Mix the spore suspension vigorously by hand and decant amount needed for one plate (5 ml) to keep the zoospores well suspended

3) Seal the plate with transparent sealer

4) Shake the plate for 10 min at 2000 RPM to mix the neo-bavaisoflavone with the hyphae suspension

5) Centrifugate the plate at 1000 RCF for 1s and stop to collect the liquid at the bottom of the plate

6) Keep the microplate on the bench until it is read by the plate reader

7) Read the plate using the plate reader

8) Collect the plates on the bench

9) Insert collected plates to a plastic box with cloth cover and put the box in the incubator at 27° C.

### Screening of Plates:

1) Read out the plate at 3 more dates: 3d, 7d, 14d and 21d following the assay start

2) Calculate the difference of absorbance between each readout and the readout at zero time

3) Calculate the percentage of growth inhibition of each well at each time point. Use the results of the DMSO treatment of the control plate as 100% growth

4) Prepare a table of the results of hits that were repeated in all 4 repeats. Set a column for each time point.

### Results: Please see Example 6.

### Example 4

### Microplate Based Screen of Compounds Potential Bioactivity against Sclerotinia sclerotiorum

Summary: Diluted purified neo-bavaisoflavone was added to microplate wells and mixed with 50 ul of hyphae suspension and growth of the fungus starting from blended hyphae was monitored by visual inspection.

Background: Sclerotinia sclerotiorum is a fungus of belonging to the Ascomycetes and it is a soil borne pathogen. It is difficult to produce large amounts of spores of Sclerotinia sclerotiorum, that led to decision to use hyphae in this screening rather than spores for inoculation.

Materials: PDBC, PDA, PDAT, PDBT, DMSO

Equipment: Centrifuge, Shaker, Incubator

### Methods:

Inoculum Preparation of Sclerotinia sclerotiorum Hyphae:

Grow Sclerotinia sclerotiorum on PDA in tube at 21° C. for 4 days.

Transfer agar block and grow Sclerotinia sclerotiorum on PDAT in 90 mm Petri dishes at 21° C. to get growing hyphae within 3 days.

Add 50 ml of PDBT medium into a sterile 250 ml square flask.

Cut the solid medium by scalpel to 15 very small pieces (1×5 mm) and insert them into the square flask.

Grow the culture for 2 days using shaker at 21° C. and 130 RPM.

Discard the liquid and pour the hyphae on an empty Petri dish.

Cut many small pieces from the hyphae (avoid using the agar pieces) using a scalpel and insert them into a sterile 250 ml square flask containing 50 ml of PDBT medium.

Grow for 2 days at 21° C., shaking at 130 RPM to get fast growing dispersed hyphae. Chill the culture in the fridge for 1 hour.

Pour the cold culture into a 50 ml tube.

Keep the mixture on ice.

Transfer about 5 ml of the blended mixture into a 15 ml tube on ice.

Homogenize the culture in the 15 ml tube for 2 min on ice while moving the tube up and down as needed (small branching pieces should be formed).

Homogenize several batches of 5 ml as above to prepare the amount that is needed (5 ml of homogenized culture would make about 50 ml of inoculum).

Dilute a portion of the homogenate 10-fold to check the concentration of the homogenate. the concentration of the suspension should be 2×10⁴ CFU/ml (diluted 10-fold concentration should be 2000 CFU/ml).

Dilute the inoculum stock 1:10 in PDBC—2 ml in 20 ml, or calculate the dilution needed, to prepare final concentration of 2000 CFU/ml. The final number of hyphae should be 100 CFU in each well.

### Microplate Preparation for Activity Experiment:

1) Take a plate with neo-bavaisoflavone from the −20° C. freezer and thaw it on the bench for at least 20 min

2) Add 50 ul of hyphae suspension to the wells of the microplate, mix the spore suspension vigorously by hand and decant amount needed for one plate (5 ml) to keep the hyphae well suspended

3) Seal the plate with transparent sealer

4) Shake the plate for 10 min at 2000 RPM to mix the neo-bavaisoflavone with the hyphae suspension

5) Centrifugate the plate at 1000 RCF for 1s and stop to collect the liquid at the bottom of the plate

6) Collect the plates on the bench until all microplates are ready for incubation

7) Insert microplates into a plastic box and put the box in the incubator at 21° C.

### Screening of Plates:

1) Screen plate at 5 dates: 4, 7, 14 and 21 days after inoculation

2) Use a lamp for visual assessment of compounds effect on fungal growth overtime

3) Screen plates after removing their cover, if there is liquid on the cover (from inside) evaporate the liquid by a heated block at 60° C.

4) Compare the hyphal growth of each well to the hyphal growth of the control plate wells (Wells containing active fungicides or 0.5% DMSO solution)

5) Write the results on a special form: clear well=3 (no growth of hyphae), normal hyphal structure=1 (normal growth), inconclusive=2 (solid structure of unexpected type, or partial cover of the area)

### Example 5

### Microplate Based Screening of Compounds for Potential Bioactivity against Pseudomonas syringae

Summary: Diluted purified neo-bavaisoflavone was added to microplate wells and mixed with 100 ul of frozen bacteria suspension and growth of the bacteria was monitored by visual inspection.

Background: Pseudomonas is a rod-shaped Gram-negative bacterium. Frozen bacteria stock of 60% glycerol was used as an inoculum for the screening experiment.

Materials: LB, LBA, DMSO

Equipment: Centrifuge, Shaker, Incubator

### Methods:

### Pseudomonas Suspension Preparation:

1) Grow Pseudomonas on LBA plates at 28° C. for 2 days to get a single colony

2) Transfer a single colony using a sterile toothpick into a 50 ml sterile tube containing 5 ml LB and grow for 24 at 28° C. and 150 RPM

3) Chill the tube in the fridge for 1 h

4) Add 7.5 ml of fridge cold, sterile, glycerol solution to the tube—to get 60% glycerol solution

5) Mix well but gently to get perfect mixing—use vortex at 1000 RPM

6) Aliquot 100 ul of bacteria suspension in 60% glycerol into 1.5 ml tubes—each aliquot should yield amount enough for screening of 10 microplates

7) Store the bacteria suspension in 60% glycerol at −20° C.

### Pseudomonas Suspension Preparation for Screening:

1) Take 1.5 ml tube with 100 ul frozen Pseudomonas suspension from the freezer and thaw it on ice

2) Prepare in the hood 50 ml tubes with 40 ml fridge cold LB

3) Mix 40 ul of bacteria suspension with 40 ml fridge cold LB in a 50 ml tube. This amount is enough for activity screening of 10 microplates

4) Use this suspension for screening experiments

### Microplate Preparation for Activity Experiment:

1) Take a plate with Neo-bavaisoflavone (10 ul) from the −20° C. freezer and thaw it on the bench for at least 20 min

2) Add 80 ul of bacteria suspension with growth medium to each well of the microplate using a multi-pipette

3) Seal the plate with transparent sealer

4) Shake the plate for 10 min at 2000 RPM to mix the Neo-bavaisoflavone with the bacteria suspension

5) Centrifugate the plate at 1000 RCF for 1s and stop to collect the liquid at the bottom of the plate

6) Insert the plates to a plastic box with cover and put the box in the incubator at 28° C.

### Screening of Microplates:

1) Screen the microplate at 5 dates: 3, 5, 7, 14 and 21 days after inoculation

2) Use a lamp to visually evaluate the bacterial growth

3) Prepare plates for screening: shake plate at 2000 RPM for 2 min to suspend the bacteria and then centrifuge plate at 1000 RCF for a few seconds

4) Screen the microplates after removing their cover, if there is liquid on the cover (from inside) evaporate the liquid using a heated block at 60° C.

5) Compare the transparency of each well to the transparency of the control wells (wells containing control bactericide or 0.5% DMSO solution)

Write the results on a special form: clear=3 (no growth of bacteria), turbid=1(normal bacterial growth), inconclusive=2 (very low turbidity compared to growth in 0.5% DMSO solution)

### Results: Please see Example 6.

### Example 6

### Results of In Vitro Experiments Based on Protocols of Examples 1-5

### In-Vitro Screening Matrix

Neo-bavaisoflavone was screened against 11 agricultural pests (as indicated in the table below). The bioactivity values are in % and reflect the potential of eradicating the target pests.

Rules for Bioactivity Relative Value Calculation (Expressed in % from Maximal Value)

a. Puccinia sorghi, Phytophthora infestans—activity grade (1/2/3) X repeats#/12 (maximal value 3×4=12)*100

b. Pseudomonas syringae, Rhizoctonia solani, Fusarium oxysporum, Pythium aphanidermatum—activity grade (1/2/3) X repeats# X days of activity/252 (maximal value 3×4×21=252)*100

c. Botrytis cinerea—activity grade (1/2/3) X repeats# X days of activity/168 (maximal value 3×4×14=168)*100

d. Pectobacterium carotovorum—activity grade (1/2/3) X repeats# X days of activity/84 (maximal value 3×4×7=168)*100

TABLE 1
Bioactivity values of Neo-bavaisoflavone on various target pests

| Pathogen | Relative Activity value (%) |
|---|---|
| Puccinia sorghi | 75 |
| Phytophthora infestans | 0 |
| Botrytis cinereal | 0 |
| Rhizoctonia solani | 75 |
| Pythium aphanidermatum | 75 |
| Fusarium oxysporum | 0 |
| Sclerotinia sclerotiorum | 17 |
| Pectobacterium carotovorum | 0 |
| Pseudomonas syringae | 100 |
| Mizus Persicae | 0 |
| Spodoptera litoralis | 0 |

In summary, Neo-bavaisoflavone is an effective pesticide against the following pests: Puccinia sorghi (first positive results are provided below in in-planta results section), Rhizoctonia solani, Pythium aphanidermatum, Sclerotinia sclerotiorum and Pseudomonas syringae.

### Example 7

### Formulation Preparation for In-Planta Validation

### Formulation 1 (Compound: Dimethyl-Sulfoxide)

In order to assist the compound dissolution to final working concentration and its spread over the sprayed surface first dry weighed Neo-bavaisoflavone was dissolved in dimethyl-sulfoxide solvent with 1:9 ratio and then brought up to the final volume used for the validation with double distilled water. Before spraying, non-ionic detergent tween 20 was added to final concentration of 0.05%.

### Formulation 2 (Compound: Tween 20: Ethanol)

In order to assist the compound dissolution to final working concentration and its spread over the sprayed surface first dry weighed Neo-bavaisoflavone was dissolved in absolute ethanol with 1:8 ratio, sonicated for 5 mins and then another part of non-ionic detergent tween 20 was added for formulation finalization. Before spraying, additional amount of 0.05% tween 20 was added (disregarding amount of tween 20 added before).

Signum was sprayed on the leaves as an aqueous suspension containing 500 ppm concentration of the commercial formulation. For suspension preparation 0.5 g of commercially available formulation was diluted with DDW up to 1000 ml and vigorously mixed.

### Formulation 3: (Compound: Dimethyl-Sulfoxide: Xanthan Gum: Silwet L-77)

NBI was dissolved in DMSO to obtain 10% solution. To get the final formulation, double distilled water (DDW) was added up to final working concentration of NBI (400 ppm). To improve delivery of the sprayed molecule to surface and ensure proper uptake of the active ingredient, an adjuvant (Xanthan Gum, 0.04%) and surfactant (Silwet L-77, 0.06%) were added to the formulation.

### Formulation 4: (Compound: Water: Xanthan Gum: Silwet L-77)

NBI was grinded in DDW (to obtain 1% suspension) using the grinder into fine powder. To get the final formulation, the DDW was added up to final working concentration of NBI was obtained—400 ppm. To improve delivery of the sprayed molecule to surface and ensure proper uptake of the active ingredient, an adjuvant (Xanthan Gum, 0.04%) and surfactant (Silwet L-77, 0.06%) were added to the formulation.

### Example 8

### In-Planta Validation in Corn

Protocol name: Puccinia infection of corn seedlings test

General description: inoculation on corn, collection, preparation of spore suspension and material activity study, of Puccinia sorghi.

### Method:

### Preparation of Corn Seedling for Inoculation

1) Use 120×80×80 mm pots

2) Use standard garden soil with fertilizer

3) Use corn seeds of a rust sensitive variety

4) Put pots in a tray

5) Fill the pots with the soil to the top

6) Make a small grove for the seeds

7) Plant about 10 seeds of corn in each pot

8) Cover the seeds with additional soil

9) Add water into the tray—about 100 ml for each pot (fill the tray 3 times). Soil should be wet and no water should be left in the tray after 24 h

10) Grow the corn for 8 days in growth room at 22° C. (until the second leaf is emerged)

Preparation of Spore Suspension [from Corn Leaves] for Inoculation

1) Insert 20 infected corn leaves with spores into a sterile 50 ml tube

2) Add 50 ml of cold 0.05% Tween 20 solution

3) Insert the tube into a sealed, ice cold plastic box

4) Shake the box using a shaker for 15 min at 3000 RPM

5) Transfer the suspension (without the leaves) into a clean sterile 50 ml tube

6) Filter the spore suspension through 16 layers of gauze into another sterile 50 ml tube

7) Keep the tube with the spore suspension on ice

8) Wash and concentrate the spores on a 5 micron membrane filter. Was 4 times with ice cold sterile water and collect the spores in 0.05% Tween 20 solution

9) For inoculation, dilute the spore suspension to get spore concentration of 8000 spores/ml using cold 0.05% Tween 20 solution

### Growth Room Experiments:

Use 8 days old seedlings prepared as explained above
Prepare treatment for spraying—about 1 ml for each plant
Add Tween 20 up to 0.05% to the treatments
Spray treatment on to the leaves till full saturation (use a spray bottle) and let dry in the growth room
Repeat spray on the second day and let dry
On the second day (after about 4 hours from the treatment spray) inoculate plants using the Puccinia spore suspension
Use spraying bottle to spray about 1 ml (till full saturation) of the spore suspension on to the leaves of 9 days old corn seedlings
Put the pots with the inoculated seedlings in a dark moist chamber with heated water at the bottom. The chamber should be held in a room at 22° C. for 24 h with 99% humidity (the temperature of the heated water should be 32° C.)
After 24 h transfer the pots to the growth room
Grow the corn in the growth room at 22° C.
After 7 days from inoculation, brown spots should be seen on the leaves
Record leaf coverage of Puccinia brown spots after 9 days from inoculation
Compare leaf coverage of treated seedlings to water treated seedlings

### Results.

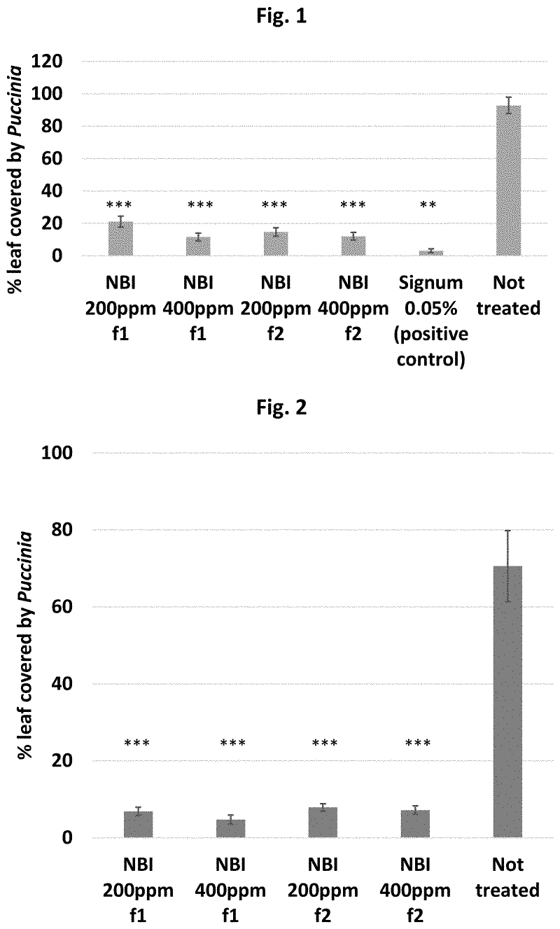

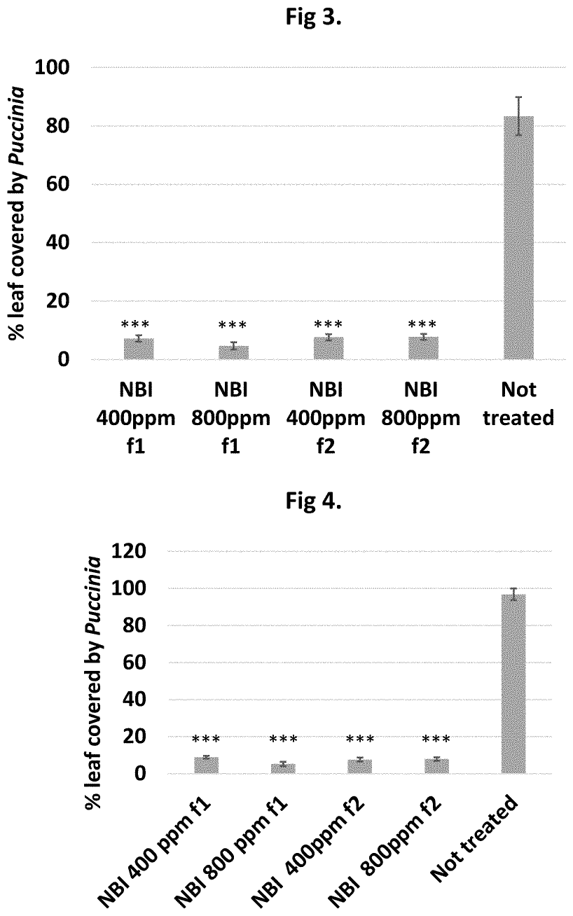

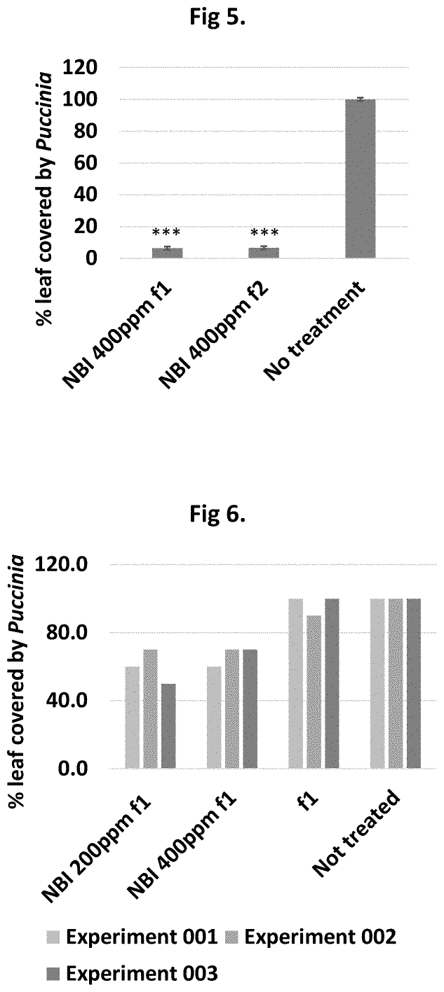

We conducted 5 independent experiments under controlled environment in growth rooms where we estimated neo-isobavaflavone's (NBI) potential to prevent and control Puccinia sorghi in corn plants (FIGS. 1, 2, 3, 4 and 5). Neo-bavaisoflavone performed very well and showed very good efficacy in five independent experiments under controlled growth conditions. The average efficacy of neo-bavaisoflavone in preventing and controlling the Puccinia sorghi was 87.39% at 200 ppm, 91.94% at 400 ppm and 94.07% at 800 ppm.

### Example 9

### In-Planta Validation in Wheat

Puccinia triticina tritici Infected Wheat Experiment

Description of the experiment: Rust sensitive wheat variety seeds were used for experiment. The seedlings were grown in a greenhouse with no Puccinia triticina tritici. First time treatments were applied at 7 days seeding stage. The seedlings were treated with neo-bavaisoflavone at two concentrations and respective control treatments—200 and 400 ppm. Second application was performed after 24 h while plants were let dry in a temperature-controlled room at 24° C. Plants were let to dry again in a temperature-controlled room at 24° C. for 2 h, and then inoculated by Puccinia triticina tritici. Seedlings were incubated in a humidity chamber for 24 h in order to allow the development of infection and then transferred to a temperature-controlled greenhouse until the end of the experiment. Disease severity was evaluated 12 days after inoculation.

Inoculation protocol: Puccinia triticina tritici was introduced to the seedlings by spraying a suspension of the spores. Spore suspension in mineral oil (2.3 mg/ml) was sprayed at the seedlings—250 microliter per pot containing 20 seedlings.

Neo-bavaisoflavone application: The formulated neo-bavaisoflavone (formulations 1 and 2) and the respective controls were applied as an aqueous suspension. Each treatment, containing 4 pots with 20 seedlings in each, was sprayed with 20 ml treatment for each of 2 applications. This amount of application was enough to reach drainage from the leaves.

Evaluation of Disease severity and cytotoxicity: Results were evaluated 12 days after inoculation. Each treatment contained 4 pots with 20 seedlings in each. Each pot was evaluated separately by visual assessment and the average of the treatment (average of 4 pots) was calculated. Disease severity was evaluated according to a 0-5 rust coverage levels; no coverage at all—0, 100% coverage of leaf area with rust—5.

Cytotoxicity of the treatments was evaluated according to a 0-3 burns of edges of leaves, levels; no burns at all—0, all leaves edges burned—3.

Treatments: Neo-bavaisoflavone was evaluated at different concentrations and was dissolved in DMSO. Other treatments included the following:

1. Water (untreated)

2. Formulation ingredients (DMSO) of each treatment as were applied for the highest concentration

Statistical analysis for in-planta validation experiments: To evaluate the effect of a compound in infected plants compared to control plants (infected but not treated) the data was analyzed by Student's t-test and the p value is calculated. The minimum number of repeats in each experiment was 3. Results were considered significant if p<0.05.

### Results.

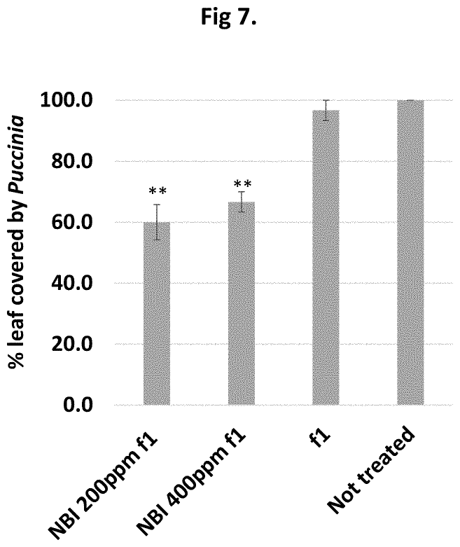

We conducted 3 independent experiments in greenhouse where we estimated neo-bavaisoflavone's (NBI) potential to prevent and control Puccinia triticina in wheat plants (FIG. 6). Each bar in FIG. 6 represents average of four replicates per treatment. Neo-bavaisoflavone controlled the leaf rust with the following efficacies: between 30% to 50% at 200 ppm and between 30% to 40% at 400 ppm. One additional experiment was conducted under controlled temperature in growth room conditions (FIG. 7) where neo-bavaisoflavone controlled the wheat leaf rust with the efficacy up to 40% at 200 ppm.

### Example 10

### In-Planta Validation in Wheat

Puccinia stritiformis Infected Wheat Experiment

Field validation in wheat: We conducted 2 independent field experiments where we estimated Neo-bavaisoflavone's (NBI's) potential to prevent and control Puccinia stritiformis (yellow rust) in wheat plants from several different cultivars in curative approach. The experiments were conducted in two independent sites in Israel, with different weather and rainfall conditions (600 mm-300 mm rain/season; Average seasonal temp: range between 19-20° c./day, 10-13° c./night).

The effect of NBI on Puccinia striiformis leaf infection was determined by measuring two different parameters: (a) relative leaf area covered by the fungus; and (2) visual viability and amount of the uredospores of rust fungi in pustules formed on wheat leaves.

(a) The effect of NBI (formulations 3 and 4) on wheat leaf infection intensity by Puccinia striiformis was determined at day 0, 7- and 14 following treatment (experiment 102) or at day 0 and 7 (experiment 108). Leaf infection intensity was calculated relative to the % of fungus coverage in the non-treated leaves. All other treatments were estimated relatively to the reference treatment, “Signum” (pyraclostrobin+boscalid).

Statistical analysis for validation of significance in field experiments: To evaluate the effect of a compound in infected plants treated with NBI, formulation only or non-treated plants (infected but not treated), the data was analyzed by Student's t-test and the p value was calculated. Results were considered significant if p<0.05. One, two or three asterisks (*, **, ***) represent significance with p<0.05, 0.01, 0.001, whereas n.s indicate non-significant comparing to non-treated control.

(b) The effect of NBI (formulation 4) on amount of uredospores of rust fungi in pustules formed on wheat leaves sampled at 0- and 7-days after fungicides application via spraying (this was assessed only in experiment 108). Wheat leaves were sampled in the field and kept at high humidity and cool temperature until observed. Four pustules in each of five leaves of wheat were sampled for the quantitative analysis. Leaves were observed under light microscope with upper source of light. Spores maintaining integrity and collapsed spores in each selected pustule were counted. The percent of collapsed spores was calculated.

The statistical analysis was done using ANOVA variance test using 0.95 confidence level.

In order to improve delivery of the sprayed molecule to surface and ensure proper uptake of the active ingredient, an adjuvant (Xanthan Gum, 0.04%) and surfactant (Silwet L-77, 0.06%) were added to the NBI solution to generate formulations 3 and 4.

### Results:

TABLE 2
Observation of uredospores of yellow (strip) rust
on field-treated wheat leaves (experiment 108)

| | | Uredospores in pustules (No. ±SE) | | | | |
|---|---|---|---|---|---|---|
| | | | | Number of | | |
| | | | | collapsed | | |
| Sampl- | | Number of | | spores | Collapsed | |
| ing | | uredospores/ | | (No./ | spores | |
| time | Treatment | pustule | | pustule) | (Percent) | |
| Day 0 | NBI | 14.8 ± 3.37 | b | 4.8 ± 2.03 | 36.8 ± 13.03 | a |
| Day 0 | Signum | 6.6 ± 2.79 | c | 5.5 ± 2.20 | 38.2 ± 4.27 | a |
| Day 0 | Not treated | 28.3 ± 8.29 | a | 1.9 ± 0.97 | 7.4 ± 4.75 | b |
| Day 7 | NBI | 6.5* | | 0.8 | 1.9 | |
| Day 7 | Signum | | | | | |
| Day 7 | Not treated | 52.5* | | 0.8 | 1.9 | |

Sampling time—after field treatment
*At day 7 only one case was observed, with no replicates.
a, b and c denote that all treatment are significantly differ from each other with p < 0.05.

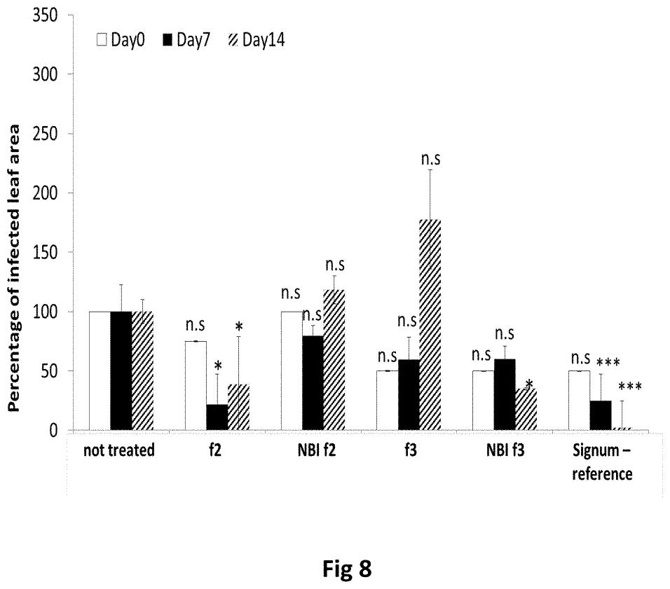

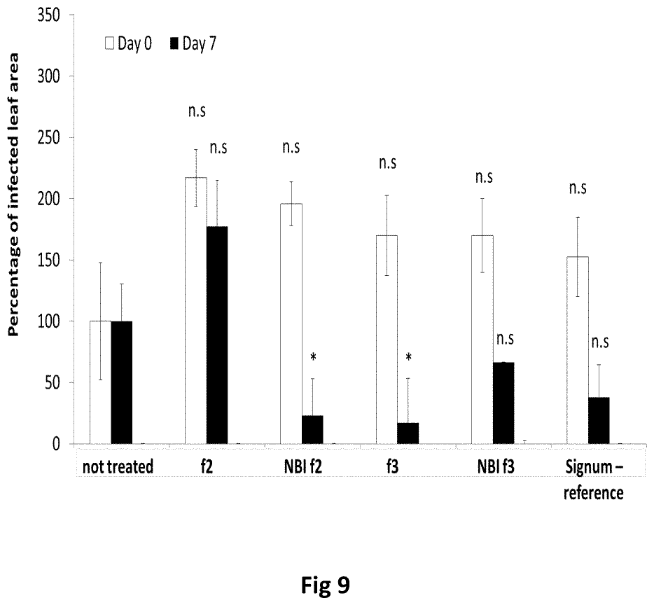

(a) NBI controlled yellow rust with the efficacies: between 60% to 80% at 400ppm using formulation 3 and formulation 4, 7- and 14-days following treatment, respectively. We assume that the differences in NBI efficacy in different field experiments in wheat plants can be explained by variabilities in specific field conditions, along the season (FIG. 8 and FIG. 9 (experiment 102 and 108, respectively). Each bar in FIG. 8 represents average of 30 replicates per treatment.

(b) Pustules of yellow rust were observed on leaves sampled at day 0. NBI significantly reduced the number of uredospores in a single pustule at day 0.

Percentage of collapsed spores was similar among the tested chemicals. The present collapse of spores was significantly higher in tested fungicides than in the water treated control at day 0 (Table 2).

### CONCLUDING REMARKS

NBI significantly reduced the relative leaf area covered by the fungi.
NBI significantly reduced the number spores of the pathogens in their produced pustules.
Collapse of the spores was higher on leaves from treated plants.

### REFERENCES

Erlacher A., Cardinale M., Grosch R., Grube M., Berg G. The impact of the pathogen Rhizoctonia solani and its beneficial counterpart Bacillus amyloliquefaciens on the indigenous lettuce microbiome. Front Microbiol. 2014; 5: 175. Published online 2014 Apr. 21. doi: 10.3389/fmicb.2014.00175.

Hershman D. E., Sikora E. J., Giesler L. J. Soybean Rust PIPE: Past, Present, and Future. Journal of Integrated Pest Management, Volume 2, Issue 2, 1 Oct. 2011, pp D1-D7, https://doi.org/10.1603/IPM11001.

Moore. L. W. Pseudomonas syringae: disease and ice nucleation activity. Ornamentals Northwest Newsletter. (1988) 12:4-16.

Hofte M. and De Vos P. Plant pathogenic Pseudomonas species. Gnanamanickam S. S. (ed.), Plant-Associated Bacteria, 2006; 507-533.

Mesfin Kebede Gessese. Description of Wheat Rusts and Their Virulence Variations Determined through Annual Pathotype Surveys and Controlled Multi-Pathotype Tests. Advances in Agriculture, 2019; Article ID 2673706.

Groth, J. V., Zeyen, R. J., Davis, D. W., & Christ, B. J. (1983). Yield and quality losses caused by common rust (Puccinia sorghi Schw.) in sweet corn (Zea mays) hybrids. Crop Protection, 2(1), 105-111.

Nzungize J R (1), Lyumugabe F, Busogoro J P & Baudoin J P. Pythium root rot of common bean: biology and control methods. A review. Biotechnol. Agron. Soc. Environ. 2012 16(3), 405-413.

Sedláková V., Dejmalová J., Hausvater E., Sedlák P., Dolez̆al P. & Mazáková J. Effect of Phytophthora infestans on potato yield in dependence on variety characteristics and fungicide control. PLANT SOIL ENVIRON., 57,2011 (10): 486-491.

Mizubuti, E. S. G. Special issue on white mold—Sclerotinia sclerotiorum. Trop. plant pathol. 44, 1-2 (2019).

Bronikowska, J., Szliszka, E., Czuba, Z. P., Zwolinski, D., Szmydki, D., & Krol, W. (2010). The Combination of TRAIL and Isoflavones Enhances Apoptosis in Cancer Cells. Molecules, 15(3), 2000-2015.

1. A method for controlling, preventing, reducing or eradicating the instances of plant-pathogen infestation on a plant, plant organ, plant part, or plant propagation material, the method comprising applying to a plant, plant part, plant organ or plant propagation material, or to soil surrounding said plant, either a pesticidally effective amount of neo-bavaisoflavone or an agriculturally acceptable salt thereof or a pesticide composition comprising a pesticidally effective amount of neo-bavaisoflavone or an agriculturally acceptable salt thereof,
wherein said plant-pathogen is a member selected from: a class of Basidomycetes selected from Pucciniomycetes and Agaricomycetes; an oomycete of the family Pythiaceae; a bacterium of the order Pseudomonadales; and an Ascomycete of the family Sclerotiniaceae.

2. The method of claim 1, wherein said plant-pathogen is a member of the class Pucciniomycetes of the order Pucciniale.

3. The method of claim 2, wherein said Pucciniale plant-pathogen is a member of the family Pucciniaceae.

4. The method of claim 3, wherein said Pucciniaceae plant-pathogen is a member of the genus Puccinia spp.

5. The method of claim 4, wherein said Puccinia spp plant-pathogen is selected from Puccinia Sorghi, Puccinia triticina and Puccinia stritiformis.

6. The method of claim 1, wherein said plant-pathogen is a member of the class Agaricomycetes of the order Cantharellales.

7. The method of claim 6, wherein said Cantharellales plant-pathogen is a member of the family Ceratobasidiaceae.

8. The method of claim 7, wherein said Ceratobasidiaceae plant-pathogen is a member of the genus Rhizoctonia spp.

9. The method of claim 8, wherein said Rhizoctonia spp. plant-pathogen is Rhizoctonia Solani.

10. The method of claim 1, wherein said plant-pathogen is a member of the family Pythiaceae of the genus Pythium spp.

11. The method of claim 10, wherein said Pythium spp. plant pathogen is Pythium aphanidermatum.

12. The method of claim 1, wherein said plant-pathogen is a member of the order Pseudomonadales of the family Pseudomonadaceae.

13. The method of claim 12, wherein said Pseudomonadaceae plant-pathogen is a member of the genus Pseudomonas spp.

14. The method of claim 13, wherein said Pseudomonas spp. plant-pathogen is Pseudomonas syringae.

15. The method of claim 1, wherein said plant-pathogen is a member of the family Sclerotiniaceae of the genus Sclerotinia spp.

16. The method of claim 15, wherein said Sclerotinia spp. is Sclerotinia sclerotiorum.

17. A pesticide composition comprising neo-bavaisoflavone or an agriculturally acceptable salt thereof.
